(19) United States
(12) Patent Application Publication
(10) Pub. No.: US 2003/0028801 A1
(43) Pub. Date: Feb. 6, 2003

(54) System and method for preventing unauthorized copying of electronic documents

(75) Inventors: David Liberman, South Caulfield (AU); Darren Deason, Elwood (AU)

Correspondence Address: David B. Ritchie, THELEN REID & PRIEST LLP, P.O. Box 640640, San Jose, CA, 95164-0640, US

(73) Assignee: CopySeal Pty Ltd., an Australian Corporation

(21) Appl. No.: 10/120,887

(22) Filed: Apr. 10, 2002

(30) Foreign Application Priority Data
Apr. 12, 2001 (AU) PR4395

(51) Int. Cl. G06F 12/14

(52) U.S. Cl. 713/200

(57) ABSTRACT

Spaces between words in a web document may be identified and replaced with at least one random character in order to deter users from copying the web document. Random characters may also be inserted within words in the web document. The random characters are invisible when the user views the web document through a browser but visible when the user attempts to select, copy, or print the web document. The random characters may be of the same color as the background color of the web document. To further deter the user, the mouse, menu, and/or keyboard functions on the user computer may be disabled. To prevent the user from viewing the source code of the web document, the source code may also be encrypted. A small tracking image having a unique identification number may be added to the web document to allow an owner of the web document to trace unauthorized use of the web document on another web site.

### CROSS-REFERENCES

The present application claims the benefit under 35 USC 119(e) of Australian Provisional Patent Application Number PR4395, filed Apr. 12, 2001 in the name of inventors David Liberman and Darren Deason, commonly assigned herewith.

### FIELD OF THE INVENTION

The present invention relates to the field of online publishing. More particularly, the present invention relates to the protection of documents from unauthorized copying.

### BACKGROUND OF THE INVENTION

With the advent of electronic networks such as the Internet, information has become more readily available and more readily accessible. This ease of dissemination has greatly expanded the marketplace for online traders and has also provided the general public with greater access to useful information and materials. One disadvantage for those who post their material on an Internet site, however, is that direct copying of that material is quite common.

For example, it is not unusual for third parties to directly copy and paste material of interest to them into another program or to print it as a hard copy. This makes it very difficult for people who manage Internet sites to protect their intellectual property and other material that they do not wish to be copied without authorization. More particularly, it is counter-productive for the owner of the material to allow users to freely copy where the owner could normally obtain a fee for its provision.

To address this problem, some Internet sites have developed an approach wherein third parties pay to view the material. This may take the form of subscriptions or specific charges per document. While this approach is successful in preventing unauthorized viewing, in practice it has been found that users can still copy the material after viewing it. For example, term papers published on some Internet sites may be viewed as freely copyable. Students accessing web sites where the material resides may view and decide to copy and paste sections of a term paper or even the entire term paper. Even if one student pays to access a restricted web site, he or she will be able to share the copied document with other students.

One reason a satisfactory solution has not yet been provided to this problem is because of the nature of the Hypertext Markup Language (HTML), which is the predominant language used to display Internet pages in a browser. HTML is an open source language that does not contain any features to prevent people from viewing the source code. As the HTML code contains all the text on the page, it is very easy to “view the source” of the page and hence view the text. Additionally, even if the source code were not available, most browsers permit cutting and pasting text displayed in a browser to any other program.

For these reasons, a further attempted solution to this problem has been to use plugins or to encrypt the page content using applets or active-x components. However, there are many disadvantages with using these approaches. For example, in order to be able to utilize plug-ins, users need to download software onto their computer, which is generally time consuming and inconvenient. Further, plug-ins, applets and active-x components can all greatly affect the speed of the web site, so there are also serious performance issues to be considered, as well as compatibility issues with certain browsers and platforms. With active-x components, there are also several utilities available on the market which reverse engineer active-x controls, so it is not a fail-safe protection mechanism.

A need therefore exists for a system and/or method that deters and prevents unauthorized copying and/or printing of electronic documents over on-line networks regardless of browser and platform compatibility. One purpose of the present invention is to solve that need and provide further, related advantages.

### BRIEF DESCRIPTION OF THE INVENTION

Spaces between words in a web document may be identified and replaced with at least one random character in order to deter users from copying the web document. Random characters may also be inserted within words in the web document. The random characters are invisible when the user views the web document through a browser but visible when the user attempts to select, copy, or print the web document. The random characters may be of the same color as the background color of the web document. To further deter the user, the mouse, menu, and/or keyboard functions on the user computer may be disabled. To prevent the user from viewing the source code of the web document, the source code may also be encrypted. A small tracking image having a unique identification number may be added to the web document to allow an owner of the web document to trace unauthorized use of the web document on another web site.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a ladder diagram illustrating a method for deterring unauthorized copying and printing of web document in accordance with one embodiment of the present invention.

FIG. 2A is a screen shot of a web browser illustrating a text viewed and protected with a method for preventing unauthorized copying and printing in accordance with one embodiment of the present invention.

FIG. 2B illustrates a screen shot of a web browser illustrating a text selected and protected with a method for preventing unauthorized copying and printing in accordance with one embodiment of the present invention.

FIG. 3 is an example of a source code of an HTML document in accordance with one embodiment of the present invention.

FIG. 4 is an example of a source code of a protected HTML document in accordance with one embodiment of the present invention.

FIG. 5 is a flow diagram illustrating a method for modifying an electronic document in accordance with one specific embodiment of the present invention.

FIG. 6 is a flow diagram illustrating a method for disabling browser functions in accordance with one specific embodiment of the present invention.

FIG. 7 is a flow diagram illustrating a method for encrypting an electronic document in accordance with one specific embodiment of the present invention.

FIG. 8 is a block diagram illustrating an encrypted and protected document in accordance with one specific embodiment of the present invention.

FIG. 9 is a block diagram illustrating an apparatus for deterring unauthorized copying and printing of web document in accordance with one specific embodiment of the present invention.

### DETAILED DESCRIPTION

Embodiments of the present invention are described herein in the context of a system and method for preventing unauthorized copying of electronic documents. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a solution for deterring unauthorized copying of electronic documents by inserting characters in the text of the electronic documents so that when copied or printed, the selected text appears corrupted. However, when viewed through a web browser, the protected electronic documents appear unchanged. This discourages users from copying the text of a document on a remote server accessed through their web browser. To further prevent unauthorized copying, the browser copying and printing functions may be disabled so that users may not have access to those functions when they are viewing the protected document through their web browser. The source view of the Hypertext Markup Language (HTML) code may be also encrypted to prevent users from viewing the original source code.

For illustrative purposes, the present application will discuss the protection of standard HTML documents that are served through a browser or as email via for example, Simple Mail Transfer Protocol (SMTP). One of ordinary skill in the art will recognize however that the solution may be applied to any electronic document format, and should not be limited to HMTL. In accordance with a specific embodiment of the present invention, spaces between words in a document are replaced with characters that may be of various colors, the same or approximate color to the background color of the web page viewed. This solution allows the user to view the web page content while using an application, but when the content is selected on the web page in an attempt to copy or print, these additional characters then become visible. This makes the copied web page content complicated and confusing to read, thus discouraging copying. The copied web page may appear corrupted to the viewer. These characters may be random characters or specific characters based on any pattern. In addition to the replacement of spaces with characters, a number of additional security measures may be implemented.

In accordance with a specific embodiment of the present invention, a JavaScript method may be utilized to further protect content data against copying. This method operates in conjunction with Internet web pages. In this regard, when a user requests access to a particular document available on a web page, for which copy protection is required, the program will operate so as to first check whether or not the user's browser is and has JavaScript enabled. While this document discusses JavaScript, one of ordinary skill in the art will recognize that other script languages may be used.

If the user's browser does not have JavaScript enabled, then the program may send an HTML message to the user, such as “Please enable JavaScript”. The program may prevent the particular document from being accessed until JavaScript is enabled by automatically redirecting it to the origin page. Therefore, if users do not enable JavaScript on their browsers, they will not be allowed to view the requested document.

For browsers with JavaScript enabled, the program may proceed onto the next step and allow the document to be opened. However in doing so, in accordance with a specific embodiment of the present invention, the program may then disable appropriate client-side browser/platform functionality. In this regard, by using Javascript to disable the right mouse button on PCs users will be prevented from accessing the right mouse button menu that includes functions such as “select all”, “view source”, and “print” options. Furthermore, certain keyboard keys, such as Ctrl-C, Ctrl-A and Ctrl-P, may be disabled such that users may be prevented from printing displayed content material and using the platform clipboard to transfer data to other applications. Similarly appropriate browser menu bar items may be disabled. Therefore, in this way the document is effectively a read-only document.

Rather than simply opening the content page at this point, the JavaScript method may make a call on a centralized server that inserts characters as will be described later in this document. The server then returns a new page with the inserted characters, further discouraging the use of the “view source” option. Additionally, the source code of this new page may even be encrypted. Thus, an invisible framed page is created that acts as a container to the content data, so that content data is sent to the user's browser in the invisible container frame. Therefore in operation, if “view source” is selected from the browser menu, a JavaScript routine will redirect the user to the container frame source rather than the content frame source.

In this way the owner of the displayed material is able to provide users of the Internet with restricted access to the documents. This is beneficial for both the Internet users and the owner of the content, as the users are able to view the document in order to determine whether they wish to purchase a copy of the document, which is not an option with “pay for view” mechanisms, and also for the owner, as by showing potential purchasers the actual content, a purchase is more likely to be made, as the uncertainty of the document content is circumvented.

To allow a user access to a copy of the document, the software program may be used to re-enable the printing, selecting and/or copying functionality of the user's browser. Alternatively an electronic copy of the document, preferably a read only version, could be provided to the user at an appropriate email address.

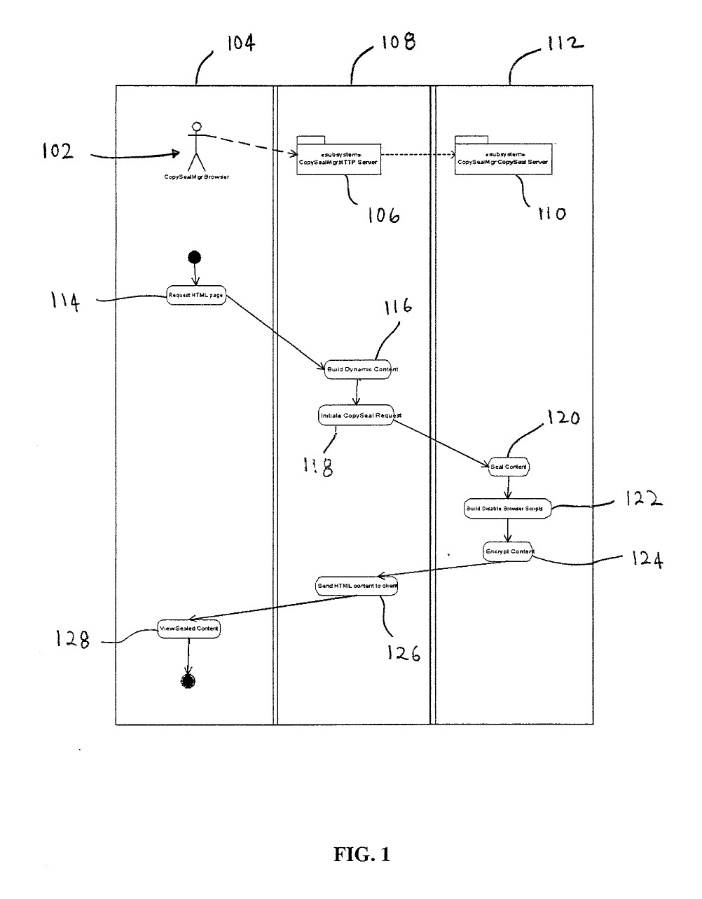

FIG. 1 is a ladder diagram illustrating a method for preventing unauthorized copying and printing in a network environment in accordance with a specific embodiment of the present invention. A user 102 utilizes a web browser on client 104 to view a document 106 on server 108. Those of ordinary skill in the art will recognize that many different web browsers exist. Other web browsers may be utilized on client 104 to view the document 106. The user 102 may access the document 106 on server 108 through a networked environment where the connection between the client 104 and the server 108 may be over Local Area Network (LAN), Wide Area Network (WAN), the Internet, and the like. The server 108 may comprise a centralized server having a database of documents accessible to the user 102 through his or her web browser on client 104. The documents on server 108 may comprise HTML documents. The server 108 interacts with a software program 110 on another server 112 that fulfills server 108's request for protecting the document 106. The software program 110 modifies the document from the database requested by the user 102 so that spaces between words in the documents are replaced with at least one random character so that when viewed by the user 102, the modified document appears unchanged. But when the user 102 selects text in the modified document, the random characters appear and makes the modified document hard to read. The software program 110 further may generate JavaScript routines that may be encapsulated with the modified document to disable mouse, menu, and keyboard functions on the user client 104 and to encrypt the source code of the modified document. To further detail the process, the following states are described.

In a first state 114, the user 102 requests an HTML page from server 108. Such request is commonly done when the user 102 clicks on a link in his or her web browser. Every time a request is received, the server 108 builds dynamic content in state 116. That is, when the user 102 requests the document 106 from the database in server 108, that document 106 is modified as needed.

The dynamic content built in state 116 results in the server 108 initiating a request to server 112 to protect and modify the document 106. The server 108 may interact with server 112 through a Web Service calling all necessary functions to provide the requested services. The Web Service allows the servers 108 and 112 to communicate with each other without interoperability problems since the Web Service is based on open standards that utilize existing infrastructure. For example, the Web Service may communicate through extensible Markup Language (XML) with HyperText Transport Protocal (HTTP).

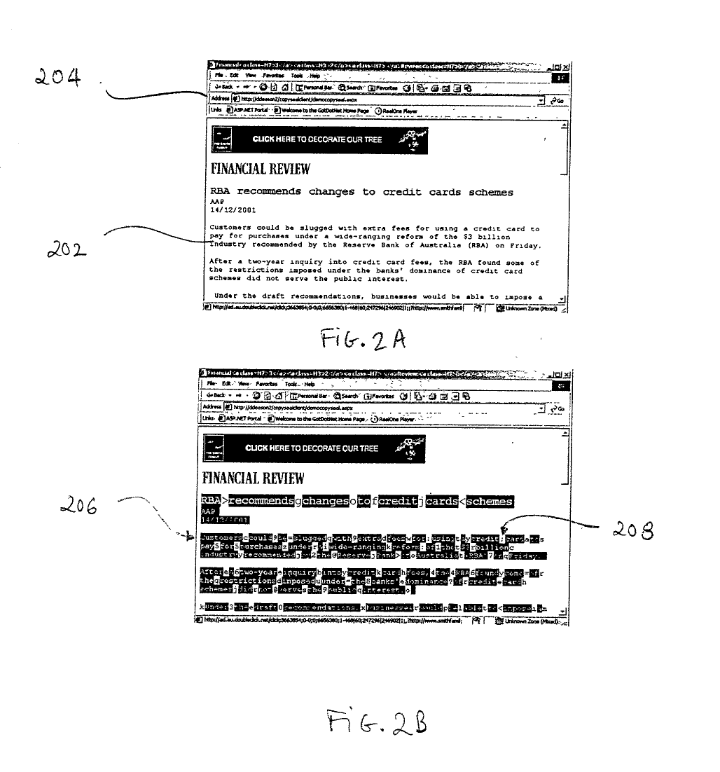

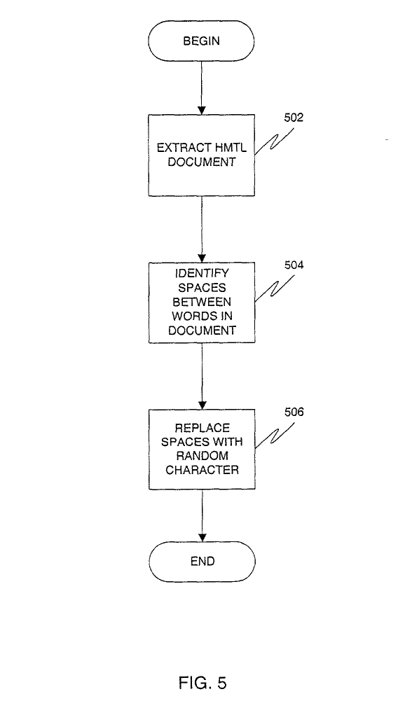

In state 120, the content is protected by inserting additional random characters in the original document 106 that appears when any portion of the content of the document is selected with a mouse or keyboard. FIG. 2A illustrates a document 202, protected with the above solution, viewed with a web browser 204 in accordance with a specific embodiment of the present invention. The text of the document 202 appears unchanged since the added random characters have a color similar to the background color of the document 202. FIG. 2B illustrates a document where a portion of the document 206 has been selected in an attempt to copy it. The selected document 206 appears corrupted with additional random characters 208 pasted along with the original text 202. This process is described in more detail in FIG. 5.

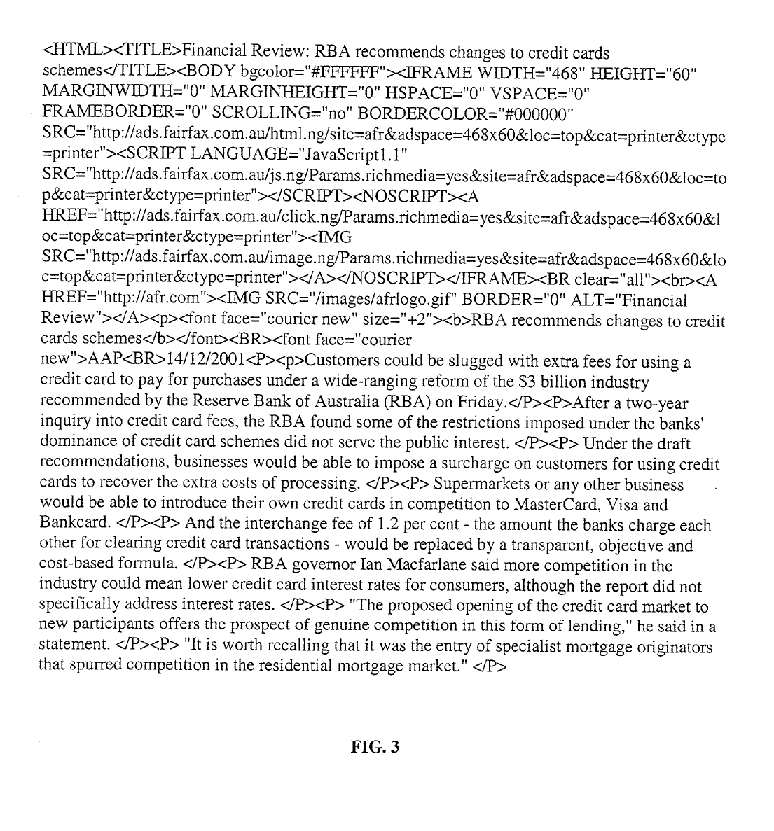

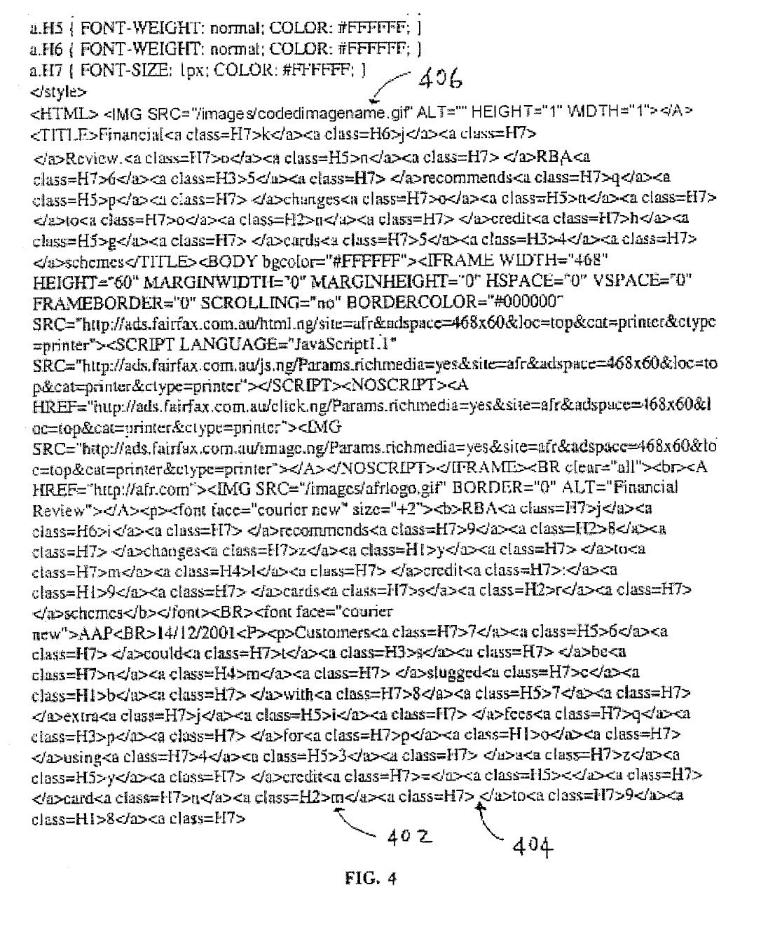

FIG. 3 illustrates an HTML source code of a document before applying the present solution. FIG. 4 illustrates an HTML source code of the document in FIG. 3 after applying the present solution. HTML tags 402 corresponding to random characters have been inserted between each word in the document. Furthermore, since the random character tags have a color same as background color of the document, HTML tags 404 representing spaces have been introduced to compensate for the replacement of the HTML tags 402 with the space that existed between each word in the document.

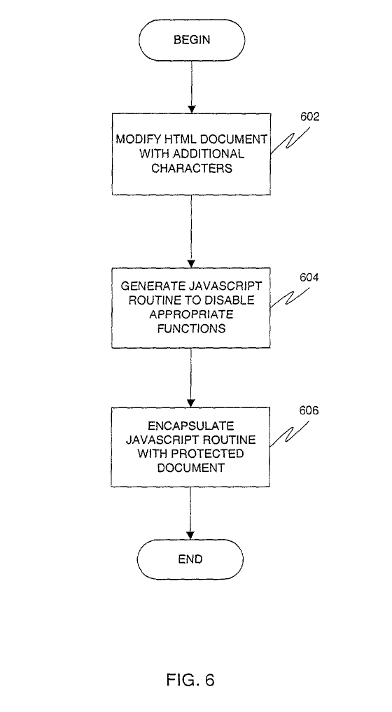

In accordance with another embodiment of the present invention, in state 122, right click contextual menu functions are also disabled when presenting the document 106 in the web browser to further deter inappropriate use of content. The web page displayed does not include tool and navigation bars. For example, the cut, copy, and paste function from the toolbar menu or right click mouse menu may be disabled. Other functions, such as print, view source, select all, and refresh may also be disabled in the web browser menu. This process is further described in more detail in FIG. 6.

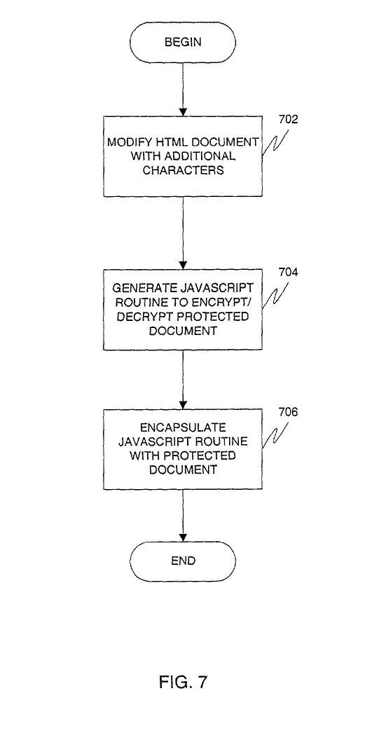

In accordance with yet another embodiment of the present invention, in state 124, the source code of the document is also encrypted to protect the user 102 from accessing the content and functionality of document 106 through a View Source browser function. This process is further described in more detail in FIG. 7.

In accordance with a further embodiment of the present invention, a tracking image may be inserted into the document prior to protecting the document. The tracking image may be 1 by 1 pixel with a unique image ID representing a unique content ID. FIG. 4 illustrates an example of an HTML tag 406 representing the unique image ID. A single copy of the HMTL tag 406 is inserted randomly into the document. The tracking image may be given an “ALT” tag to ensure that it does not compromise with other standards for images within web pages. In this particular example, the pixel size is 1 by 1. The new content ID is created each time a call is sent to initiate protection on the document. The content ID may be linked to the server 108 ID for identifying the source of the content when it is viewed by a browser allowing the client 104 to be aware of unauthorized usage of content on other web servers. Additionally, the tracking image may be used to determine the number of users who have viewed the content, and which servers served the content by IP address or domain name. Finally, the tracking image may allow tracking of both protection requests in state 118 and the viewing of protected documents in state 128.

After the software program in server 112 operates on the document 106 as requested by the server 108, the protected document is sent to the client 104 in state 126. The user 102 can then view the protected document in the web browser in state 128. However, when the user 102 attempts to copy or select text from the protected document, the protected document will appear corrupted with additional random characters. If the user 102 attempts to view the source code of the protected document, an encrypted source may be displayed instead. As an added deterrent, copy functions from the browser may also be disabled.

FIG. 5 is a flow diagram illustrating a method for modifying an electronic document in accordance with a specific embodiment of the present invention. In this embodiment, JavaScript capability is not required on the user web browser. This method discourages unauthorized copying by displaying a corrupted document when a user viewing the modified document attempts to copy, select, or print it. One embodiment of the present invention includes an implementation using a software program operating on the web page. At 502, an HTML document is extracted from a database in a server. This is done for example in FIG. 1 when the server 112 receives the request to modify the document from server 108. Spaces between words in the document are then identified at 504. At 506, character tags are inserted between each word in the electronic document. Character tags replace the spaces identified at 504. Another additional character tag may be added along with the inserted character tag. The additional character tag may have a class equal to 1px which acts as a space. This space allows the text to wrap in the web browser and thus be displayed within the browser in the same fashion as before the protection process. This protection process may also be referred as a sealing process.

In a specific embodiment of the present invention, tags for random characters replace the space between each word. The character tags may also be selected in a sequential or logical manner. In accordance with another embodiment of the present invention, any number of characters can be inserted into spaces between words in the electronic document. This prevents a character parser from deleting predictable characters in the content of the electronic document.

In another embodiment, random characters are also inserted between characters within words as well as between words. The characters set within words utilize a proportional spacing routine to ensure that the content viewed onscreen is not in any way distorted due to the protection process. The addition of characters within the content of the protected electronic document may increase its size. In particular, when characters are also inserted within words as well as between words, the size of the electronic document may significantly increase. In most instances, this would not be a concern as the additional time taken to download a text page that has been protected as opposed to the same page without protection is fairly negligible. However, in some cases, the document size may be of a concern to the users of the content. In this instance, a compression algorithm may be utilized to ensure that the content remains within a download threshold. Those of ordinary skill in the art will recognize that any compression algorithm may be used.

FIG. 6 is a flow diagram illustrating a method for disabling browser functions in accordance with a specific embodiment of the present invention. At 602, an electronic document is modified according to the process in FIG. 5 to generate a protected document. To further discourage users from copying the protected document, appropriate mouse, menu and keyboard functions are disabled at 604. Right click contextual menu functions by a mouse are disabled when presenting the protected electronic document in the web browser to further deter inappropriate use of content. The web page displayed will not include tool and navigation bars. A JavaScript routine generated in server 112 is encapsulated with the protected document in HTML at 606. The protected document in HTML along with the JavaScript routine is sent to the client 104 in FIG. 1. A check is then made to determine whether or not the user's browser has JavaScript enabled. If JavaScript is not enabled, no content is displayed, and the user is requested to enable JavaScript before the requested content will be displayed. In this regard, it would also be preferable to provide the user with instruction to enable JavaScript. If the check reveals JavaScript to be enabled, then the JavaScript routine for disabling appropriate mouse, menu and keyboard functionality is undertaken.

FIG. 7 is a flow diagram illustrating a method for encrypting an electronic document in accordance with one specific embodiment of the present invention. At 702, an electronic document is modified according to the process in FIG. 5 to generate a protected document. To further discourage users from copying the protected document, the source code of the protected document in HTML is encrypted. In another embodiment of the present invention, protected electronic document is also associated with an encryption/decryption procedure in order to discourage copying and printing of the content data in the electronic document. In this regard, at 704, server side text encryption occurs in that the content of an electronic document is encrypted using a JavaScript symmetric key. To do so, raw content data is first retrieved from a database via a look-up table using the unique content_ID field.

A symmetric key is then generated, also preferably using the unique content_ID field of the content record. This key is then used to encrypt the content. Preferably the encryption process involves incrementing/decrementing the individual character codes within the content by the value of the symmetric key. In this regard, individual content records will have their own (1 of 127) symmetric key offsets. One of ordinary skill will recognize that many encryption methods exist and any encryption method may be applied to the present solution.

At 706, the relevant HTML page is then rendered with the encrypted content and the JavaScript decryption routine, and the resultant file or files sent via HTTP/SSL to the client browser. To open the document at the client browser, the content will be decrypted using the symmetric key in the opposite manner to the previous encryption process.

By using an encryption/decryption process in this way, users are unable to view the source text. Further, by using unique content_IDs (which are the primary keys of content records held in the database) to generate symmetric keys, rather than individual browser session based private keys, efficient caching of pages is still achievable. It is to be appreciated that this advantage only applies to technologies that utilize caching.

A further advantage of using content_IDs of documents to generate symmetric keys is that the references generated using the content_IDs are readily changeable through the use of associated offset characters. Preferably these offset characters may also be configurable.

Also, all JavaScript functions are externally referenced and not included within the content page source. Hence, although encryption/decryption processes can generally be hacked, by constantly changing the function names and encryption methods used, hackers will be constantly required to reverse-engineer different routines.

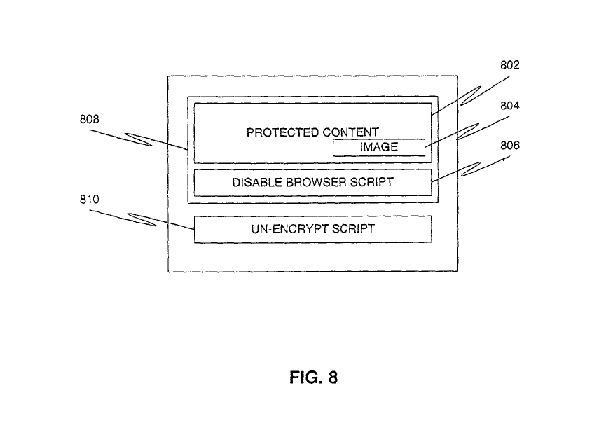

This encryption/decryption embodiment of the invention is preferably used in conjunction with the previous embodiment of the invention regarding disabling browser, mouse and keyboard functionality using Javascript in order to provide enhanced and multi-leveled protection. FIG. 8 illustrates one embodiment of an encrypted and protected document. The protected document 802 may include a tracking image 804 as previously described. A JavaScript for disabling browser and computer functions 806 is associated with the protected document 802. Both protected document 802 and disabling browser JavaScript 806 are encrypted into encrypted data 808, as previously described. An un-encryption JavaScript 810 is encapsulated with the encrypted data 808. The encapsulation of both blocks 808 and 810 is then transmitted to the client for viewing.

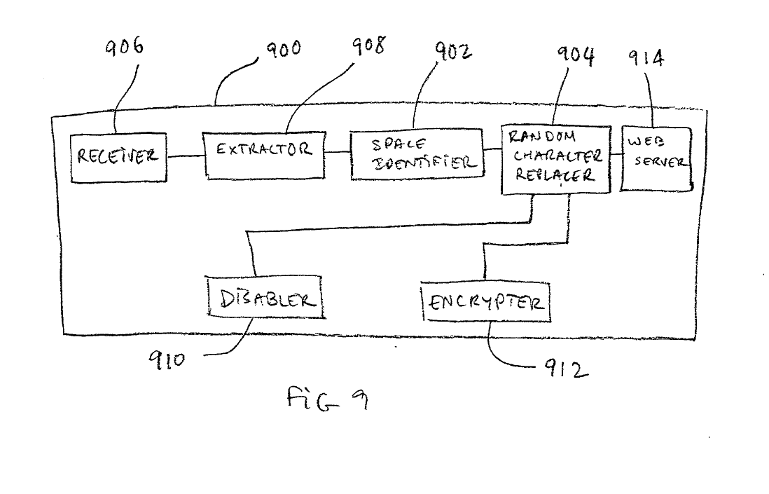

FIG. 9 is a block diagram of an apparatus 900 for deterring a user from copying a web document in accordance with one embodiment of the present invention. The apparatus includes a space identifier 902 and a random character replacer 904. The space identifier 902 identifies the spaces between words in the document. The random character replacer 904 replaces the spaces identified by the space identifier 902 with character tags identifying the character color as the same of the background color of the document. In accordance with one embodiment of the present invention, character tags include random characters. In accordance with another embodiment of the present invention, character tags may also be inserted within the words in the document. In accordance with another embodiment of the present invention, the apparatus also includes a web document receiver 906, a web document extractor 908, a mouse, menu, and/or keyboard disabler 910, a source code encrypter 912, and a server 914. The receiver 906 receives a request to protect the web document when the user attempts to access the web document. The extractor 908 extracts the web document. The disabler 910 disables the mouse, menu, and/or keyboard functions to further deter a user from copying the document. The disabler 910 may generate a JavaScript routine operating on the user computer to disable the above functions. The source code encrypter 912 encrypts the source code of the document. The source code encrypter 908 may generate a JavaScript routine operating on the user computer to encrypt to the source code. Both disabler 906 and encrypter 908 may be coupled to the random character replacer 904. The server 914 serves the web document to the user for display.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for deterring a user from copying a web document, the method comprising:
identifying spaces between words in the web document; and
replacing each of said spaces with at least one additional character, said at least one character being invisible when the user views the web document through a browser but visible when the user attempts to select, copy, or print the web document.

2. The method of claim 1 wherein said at least one additional character includes a random character.

3. The method of claim 1 wherein said at least one additional character has a font color substantially similar to a background color of the web document.

4. The method of claim 1 wherein the web document is formatted in Hypertext Markup Language (HTML).

5. The method of claim 4 wherein said replacing further comprises inserting a HMTL tag for each additional character, said tag identifying a font and a color of said additional character.

6. The method of claim 5 wherein said font of said additional character is substantially similar to a font of said words in the web document.

7. The method of claim 6 further comprising offsetting said additional character with at least one offset character, the viewed web document substantially similar to the viewed web document including said additional characters and said offset character.

8. The method of claim 1 further comprising inserting a tracking image in the web document, said tracking image including a unique identification.

9. The method of claim 1 further comprising:
disabling mouse, menu, and/or keyboard functions on the user online computer so that user is unable to print, copy or paste the web document.

10. The method of claim 1 further comprising:
encrypting the content data of the web document so that a source code of the web document when viewed by the user appears corrupted.

11. The method of claim 1 further comprising:
receiving a request to protect the web document when the user attempts to access the web document;
extracting the web document before said identifying and said replacing; and
serving the web document to the user for display after said identifying and said replacing.

12. A method for deterring a user from copying a web document, the method comprising:
identifying spaces between words in the web document; and
replacing each of said spaces with at least one additional character of same color as background color of the web document.

13. The method of claim 12 wherein said at least one additional character includes a random character.

14. The method of claim 12 further comprising:
disabling mouse, menu, and/or keyboard functions on the user online computer so that user is unable to print, copy or paste the web document.

15. The method of claim 12 further comprising:
encrypting the content data of the web document so that a source code of the web document when viewed by the user appears corrupted.

16. The method of claim 12 further comprising:
receiving a request to protect the web document when the user attempts to access the web document;
extracting the web document before said identifying and said replacing; and
serving the web document to the user for display after said identifying and said replacing.

17. A method for deterring a user from copying a web document, the method comprising:
inserting within words in the web document at least one additional character, said at least one additional character being invisible when the user views the web document through a browser but visible when the user attempts to select, copy, or print the web document.

18. The method of claim 17 wherein said at least one additional character includes a random character.

19. The method of claim 17 wherein said at least one additional character has a font color substantially similar to a background color of the web document.

20. The method of claim 17 further comprising:
disabling mouse, menu, and/or keyboard functions on the user online computer so that user is unable to print, copy or paste the web document.

21. The method of claim 17 further comprising:
encrypting the content data of the web document so that a source code of the web document when viewed by the user appears corrupted.

22. The method of claim 17 further comprising:
receiving a request to protect the web document when the user attempts to access the web document;
extracting the web document before said identifying and said replacing; and
serving the web document to the user for display after said identifying and said replacing.

23. A method for providing a user with a read-only copy of a document available over a network, the method comprising:
extracting the document from a database;
identifying spaces between words in the document;
inserting at least one random character in said spaces to form a protected document so that the protected document appears corrupted when the user attempts to select, copy, or print the document; and
supplying the user with said protected document, the user viewing said protected document with a browser.

24. The method of claim 23 further comprising:
generating a JavaScript routine executing on said browser to disable mouse, menu, and/or keyboard functions on the user online computer so that user is unable to print, copy or paste the document.

25. The method of claim 23 further comprising:
generating a JavaScript routine executing on said browser to encrypt the content data of the document so that a source code of the document when viewed using said browser appears corrupted.

26. An apparatus for deterring a user from copying a web document, the apparatus comprising:
a space identifier; and
an additional character replacer coupled to said space identifier, said additional character being invisible when the user views the web document through a browser but visible when the user attempts to select, copy, or print the web document.

27. The apparatus of claim 26 wherein said additional character includes a random character.

28. The apparatus of claim 26 wherein said additional character has a font color substantially similar to a background color of the web document.

29. The apparatus of claim 26 further comprising:
a mouse, menu, and/or keyboard functions disabler coupled to said additional character replacer.

30. The apparatus of claim 26 further comprising:
a source code encrypter coupled to said additional character replacer.

31. The apparatus of claim 26 further comprising:
a protection request receiver coupled to said space identifier;
a web document extractor coupled to said protection request receiver; and
a web document server coupled to said character replacer.

32. An apparatus for deterring a user from copying a web document, the apparatus comprising:
a space identifier; and
an additional character replacer coupled to said space identifier.

33. The apparatus of claim 32 wherein said at least one additional character includes a random character.

34. The apparatus of claim 32 further comprising:
a mouse, menu, and/or keyboard functions disabler coupled to said additional character replacer.

35. The apparatus of claim 32 further comprising:
a source code encrypter coupled to said additional character replacer.

36. The apparatus of claim 32 further comprising:
a protection request receiver coupled to said space identifier;
a web document extractor coupled to said protection request receiver; and
a web document server coupled to said character replacer.

37. An apparatus for deterring a user from copying a web document, the apparatus comprising:
an additional character inserter, said additional character being invisible when the user views the web document through a browser but visible when the user attempts to select, copy, or print the web document.

38. The apparatus of claim 37 wherein said at least one additional character includes a random character.

39. The apparatus of claim 37 further comprising:
a mouse, menu, and/or keyboard functions disabler coupled to said additional character replacer.

40. The apparatus of claim 37 further comprising:
a source code encrypter coupled to said additional character replacer.

41. The apparatus of claim 37 further comprising:
a protection request receiver coupled to said space identifier;
a web document extractor coupled to said protection request receiver; and
a web document server coupled to said character replacer.

42. A program storage device readable by a machine, tangibly embodying a program of instructions readable by the machine to perform a method for deterring a user from copying a web document, the method comprising:
identifying spaces between words in the web document; and
replacing each of said spaces with at least one random character, said at least one random character being invisible when the user views the document through a browser but visible when the user attempts to select, copy, or print the document.

43. A program storage device readable by a machine, tangibly embodying a program of instructions readable by the machine to perform a method for deterring a user from copying a web document, said method comprising:
identifying spaces between words in the web document; and
replacing each of said spaces with at least one random character of same color as background color of the web document.

44. A program storage device readable by a machine, tangibly embodying a program of instructions readable by the machine to perform a method for deterring a user from copying a web document, said method comprising:
inserting within words in the web document at least one additional character, said at least one additional character being invisible when the user views the web document through a browser but visible when the user attempts to select, copy, or print the web document.

45. An apparatus for deterring a user from copying a web document, the apparatus comprising:
means for identifying spaces between words in the web document; and
means for replacing each of said spaces with at least one additional character, said at least one character being invisible when the user views the web document through a browser but visible when the user attempts to select, copy, or print the web document.

46. The apparatus of claim 45 wherein said at least one additional character includes a random character.

47. The apparatus of claim 45 wherein said at least one additional character has a font color substantially similar to a background color of the web document.

48. The apparatus of claim 45 wherein the web document is formatted in Hypertext Markup Language (HTML).

49. The apparatus of claim 48 wherein said replacing further comprises means for inserting a HMTL tag for each additional character, said tag identifying a font and a color of said additional character.

50. The apparatus of claim 49 wherein said font of said additional character is substantially similar to a font of said words in the web document.

51. The apparatus of claim 45 further comprising:
means for disabling mouse, menu, and/or keyboard functions on the user online computer so that user is unable to print, copy or paste the web document.

52. The apparatus of claim 45 further comprising:
means for encrypting the content data of the web document so that a source code of the web document when viewed by the user appears corrupted.

53. The apparatus of claim 45 further comprising:
means for receiving a request to protect the web document when the user attempts to access the web document;
means for extracting the web document before said identifying and said replacing; and
means for serving the web document to the user for display after said identifying and said replacing.

54. A apparatus for deterring a user from copying a web document, the method comprising:
means for identifying spaces between words in the web document; and
means for replacing each of said spaces with at least one additional character of same color as background color of the web document.

55. The apparatus of claim 54 wherein said at least one additional character includes a random character.

56. The apparatus of claim 54 further comprising:
means for disabling mouse, menu, and/or keyboard functions on the user online computer so that user is unable to print, copy or paste the web document.

57. The apparatus of claim 54 further comprising:
means for encrypting the content data of the web document so that a source code of the web document when viewed by the user appears corrupted.

58. The apparatus of claim 54 further comprising:
means for receiving a request to protect the web document when the user attempts to access the web document;
means for extracting the web document before said identifying and said replacing; and
means for serving the web document to the user for display after said identifying and said replacing.

59. An apparatus for deterring a user from copying a web document, the method comprising:
means for inserting within words in the web document at least one additional character, said at least one additional character being invisible when the user views the web document through a browser but visible when the user attempts to select, copy, or print the web document.

60. The apparatus of claim 59 wherein said at least one additional character includes a random character.

61. The apparatus of claim 59 wherein said at least one additional character has a font color substantially similar to a background color of the web document.

62. The apparatus of claim 59 further comprising:
means for disabling mouse, menu, and/or keyboard functions on the user online computer so that user is unable to print, copy or paste the web document.

63. The apparatus of claim 59 further comprising:
means for encrypting the content data of the web document so that a source code of the web document when viewed by the user appears corrupted.

64. The apparatus of claim 59 further comprising:
means for receiving a request to protect the web document when the user attempts to access the web document;
means for extracting the web document before said identifying and said replacing; and
means for serving the web document to the user for display after said identifying and said replacing.

65. An apparatus for providing a user with a read-only copy of a document available over a network, the method comprising:
means for extracting the document from a database;
means for identifying spaces between words in the document;
means for inserting at least one random character in said spaces to form a protected document so that the protected document appears corrupted when the user attempts to select, copy, or print the document; and
means for supplying the user with said protected document, the user viewing said protected document with a browser.

66. The apparatus of claim 65 further comprising:
means for generating a JavaScript routine executing on said browser to disable mouse, menu, and/or keyboard functions on the user online computer so that user is unable to print, copy or paste the document.

67. The apparatus of claim 65 further comprising:
means for generating a JavaScript routine executing on said browser to encrypt the content data of the document so that a source code of the document when viewed using said browser appears corrupted.
